(19) United States
(12) Patent Application Publication
(10) Pub. No.: US 2004/0233910 A1
(43) Pub. Date: Nov. 25, 2004

(54) Storage area network using a data communication protocol

(76) Inventors: Wen-Shyen Chen, Taichung, WA (US); John Christopher Lallier, Massapequa Park, NY (US); Wayne Lam, Muttontown, NY (US); Tat-Man Lee, Forest Hills, NY (US); Jianming Wu, Commack, NY (US)

Correspondence Address: John M. Johnson, Kaye, Scholer, Fierman, Hays & Handler LLP, 425 Park Avenue, New York, NY, 10022, US

(21) Appl. No.: 09/792,873

(22) Filed: Feb. 23, 2001

(51) Int. Cl. H04L 12/28

(52) U.S. Cl. 370/395.5

(57) ABSTRACT

A method and a system for storing and/or retrieving data which can be implemented using a storage area network. The system includes a client computer having data to store or desiring data to retrieve, a storage server in communication with the client computer and able to read storage-related requests from the client computer, a high-speed network running at least one data communication protocol for communicating between the client computer and the storage server, a storage device, which has data to retrieve and is used to store data, in communication with the storage server, and a storage manager for allocating and authorizing the storage device. Preferably, the data communication protocol includes at least one of the Internet protocols, including Internet Protocol (“IP”), Transmission Control Protocol (“TCP”), and User Datagram Protocol (“UDP”). Preferably, the system also includes a high-speed switch for communicating between the client computer and the storage server. The high-speed switch and the storage server may be integrated. Preferably, the storage devices include SCSI, Fibre Channel, IDE, and/or ramdisk, although other storage device types and protocols can easily be used. The present invention also provides for mirroring, replication, high availability, and client-free server backup. Preferably, the client computer is capable of operating as both a storage area network (“SAN”) client and a network-attached storage (“NAS”) client. The storage area network provides a virtualized interface between a client computer and a storage device. A more flexible system for accessing a variety of remote peripheral devices is also described. The communication between the client computer and the peripheral device is virtualized, the remote peripheral device appearing to the client computer to be connected directly to the client computer. Each of the peripheral devices and the storage devices attached to the storage area network can appear as several layers and combinations of virtual and physical devices.

### BACKGROUND OF THE INVENTION

1. Field of the Invention

This invention relates generally to a system and method for connecting to server systems storage media such as disks and tapes. More particularly, this invention relates to connecting these devices using data communication protocols such as Internet Protocol (“IP”), Transmission Control Protocol (“TCP”), and/or User Datagram Protocol (“UDP”), which eliminate distance limitations between server systems and devices.

2. Description of the Related Art

Traditionally, computer systems connect directly to mass storage and peripheral devices, such as disk drives, tape drives, and CD-ROM drives, over a parallel bus or connection known as a “SCSI” bus. “SCSI,” which stands for “Small Computer System Interface,” is an ANSI standard for such connections. The SCSI standard includes several development generations, starting with SCSI-1, then SCSI-2 (Fast, Wide, and Fast-Wide types), and finally SCSI-3. The SCSI standard defines the physical characteristics of the connection, as well as the protocol for sending and receiving data over the connection. FIG. 1A is a block diagram of a conventional attached-storage model. The model includes a local area network (“LAN”) 100 to which is attached several servers 110, each schematically shown running a different operating system (such as Windows NT®, Solaris™, Linux, etc.), and a network-attached storage (“NAS”) appliance 120. To each of the servers 110 is attached at least one storage device, for example, disk drives 130 and disk libraries or tape drives 140. No storage device is attached to more than one server.

The primary drawbacks of using SCSI-1 and SCSI-2 for storage are the limited number of SCSI devices (generally fewer than 8) that can be addressed by each server 110 on the LAN and the limited distance (generally less than 25 meters) allowed between the server and the storage device. These limitations make it difficult to share SCSI devices between two or more computers that are physically distant from each other.

The SCSI-3 specification solves some of these problems by increasing the number of devices that can be addressed by a server 110 and increasing the distance between the server and the storage devices. In addition, the SCSI-3 specification is supported within other technologies such as Fibre Channel, which is another network standard with high bandwidth and increased distances of up to 10 km. FIG. 1B is a block diagram of a Fibre Channel storage attached network (“SAN”) connected to the servers 110 of LAN 100. Instead of attaching storage devices to specific servers 110 as in FIG. 1A, the Fibre Channel SAN 160 allows the servers 110 to access Fibre Channel storage devices 170 or, using a Fibre Channel-SCSI bridge 180, SCSI disk drives 130 or disk libraries 140.

Fibre Channel technology has overcome many of the inherent SCSI limitations by enabling systems to send the SCSI protocol over a serial fiber optic bus that does not have the same limitations on number of connections, distances, and sharing that standard SCSI buses do. However, distance limitations still exist with Fibre Channel architecture. Another major drawback of implementing Fibre Channel is that it requires installing new technology between the SCSI devices and the computers, including controllers, adapters, routers and switches. These and other hardware solutions have been developed to overcome the primary limitations of SCSI and Fibre Channel, but are technology-intensive, complicated, and costly.

U.S. Pat. No. 5,996,024 (the “'024 Patent”), issued Nov. 30, 1999, to Blumenau, overcomes several of these limitations. That reference discloses a host computer and a second computer linked via a high-speed network. The host computer includes a network SCSI device driver, and a network SCSI applications server is executing in the second computer. The high-speed network can be Megabit or Gigabit Ethernet and is able to run Internet protocol (“IP”). SCSI commands are encapsulated by the network SCSI device driver and transmitted over the network to the server, which extracts the SCSI commands and executes the SCSI commands on the SCSI devices. The reference discloses that without the use of additional hardware (e.g., by using existing Ethernet connections), the host computer is able to access a number of SCSI devices attached to the second computer as if those devices were attached to the host computer. In this manner, the reference thus appears to overcome the speed and device limitations of SCSI, while not requiring the purchase of additional hardware.

The '024 Patent is limited, however, in a number of ways. First, the '024 Patent is limited to accessing SCSI devices. Second, that system is limited to the actual SCSI devices already attached to the server or servers; there is no provision for adding SCSI devices to the system. Third, the '024 Patent discloses only a static arrangement of devices.

What is needed is a highly flexible system that, in addition to overcoming the distance and connection limitations of SCSI, is able to access devices running a variety of protocols, including SCSI, and is able to dynamically allocate these devices so as to serve the client computers.

### SUMMARY OF THE INVENTION

The present invention includes a method and a system for storing and/or retrieving data, and can be implemented using a storage area network. The system includes a client computer having data to store or desiring data to retrieve, a storage server in communication with the client computer and able to read storage-related requests from the client computer, a high-speed network running at least one data communication protocol for communicating between the client computer and the storage server, a storage device, which has data to retrieve and is used to store data, in communication with the storage server, and a storage manager for allocating and authorizing the storage device. Preferably, the data communication protocol includes at least one of the Internet protocols, including Internet Protocol (“IP”), Transmission Control Protocol (“TCP”), and User Datagram Protocol (“UDP”). Preferably, the system also includes a high-speed switch for communicating between the client computer and the storage server. The high-speed switch and the storage server may be integrated. Preferably, the storage devices include SCSI, Fibre Channel, IDE (“Integrated Drive Electronics”), and/or ramdisk, although other storage device types and protocols can easily be used. Using an additional storage device, the present invention also provides for mirroring, replication, and client-free server backup. In addition, using at least an additional storage server, the present invention also provides high availability data storage. Preferably, the client computer is capable of operating as both a storage area network (“SAN”) client and a network-attached storage (“NAS”) client. When operating as a SAN client, the data communication protocol is preferably UDP running over IP; when operating as a NAS client, the data communication protocol is preferably TCP running over IP.

Advantageously, although the system of the present invention ultimately stores data on and retrieves data from storage devices, the system includes much flexibility between the application in the client computer requesting storage or retrieval of data and the actual storing and retrieving of the data. To this end, the system of the present invention handles storage-related commands generated in the client computer and storage server and storage-related requests and replies communicated between the client computer and storage server. The client computer preferably comprises a driver which has several functions. One function is that the driver is used to enhance the reliability of UDP. Another function of the driver is to determine whether or not a storage-related command is to be communicated to the storage server. In the case where the storage-related command is not communicated to the storage-server, for example, if the command is a type of inquiry command, the driver responds to the command, although it appears to the client computer (or, more specifically, to the client computer's operating system) as though the response to the command is coming from a storage device connected directly to the client computer. In the case where the storage-related command is communicated to the storage server, the driver converts the command to a generic storage-related request that is independent of device protocols such as SCSI, IDE, or FC.

When the storage server receives the generic storage-related request, the storage server determines whether that request is to be communicated to the storage device. If not, for example, if the request involves a type of status request, the storage server responds to the generic storage-related request in the form of a generic storage-related reply, although it appears to the client computer as though the response to the request is coming from a storage device connected directly to the client computer. In the case where the generic storage-related request is communicated to the storage device, for example, if the request involves a read or a write, the request is first converted to a storage-related command, which is different from the one generated in the client computer, and then transmitted to the storage device. In the first instance, the storage device does not have to be a physical device, but can appear as a virtual device. This virtual device can include physical devices that also include further layers of virtualization. The server's storage-related command is executed on the storage device, the storage device responds to the server's storage-related command, and the storage server preferably converts this response to a generic storage-related reply for transmission back to the client computer. Again, it appears to the client computer as though the response to the original storage-related command is coming from a storage device connected directly to the client computer.

The system of the present invention exhibits further flexibility in that it is not limited to storing and retrieving data to or from storage devices. The present invention can access a variety of peripheral devices, including, for example, scanners, tape drives, CD-ROM drives, optical disks, and printers. The communication between the client computer and the peripheral device is virtualized; thus, it appears to the client computer that the peripheral device is connected directly to the client computer. The peripheral device can appear as a single virtual device, as several physical devices, or several layers and combinations of both physical and virtual.

There are several key advantages to this invention. First, because the invention uses data communication protocols, it overcomes the distance limitations imposed by SCSI and Fibre Channel. Second, users of the invention are not limited in the number of computers and storage devices that can be connected together. Third, the invention can be implemented using existing SCSI and Fibre Channel infrastructure. Fourth, the invention eliminates the need for local client computers to reallocate storage space when storage demands do not follow a predicted plan. The system creates a software implementation using standard data communication protocols over existing infrastructure to provide flexible management of storage by virtualization.

### BRIEF DESCRIPTION OF THE DRAWINGS

These and other features and advantages of the invention will be apparent to those skilled in the art from the following detailed description of preferred embodiments, taken together with the accompanying drawings, in which:

FIG. 1A is a block diagram of a conventional attached storage model;

FIG. 1B is block diagram of more contemporary conventional storage model;

FIG. 2A is a block diagram of an embodiment of the present invention;

FIG. 2B is a block diagram of another embodiment of the present invention;

FIG. 3 is a block diagram of yet another embodiment of the present invention;

FIG. 4 is a schematic diagram of the interaction between client computers and a storage server according to an embodiment of the present invention;

FIG. 5 is a diagram illustrating a preferred embodiment of the flow of client computer operations according to an embodiment of the present invention;

FIG. 6 is a diagram illustrating a preferred embodiment of the flow of storage server operations according to an embodiment of the present invention;

FIG. 7 is a diagram illustrating disk virtualization applications, performed according to an embodiment of the present invention; and

FIG. 8 is a diagram further illustrating disk virtualization according to an embodiment of the present invention; and

FIG. 9 is a block diagram showing several storage applications according to an embodiment of the present invention.

### DETAILED DESCRIPTION OF THE PREFERRED EMBODIMENTS

The present invention provides a virtualized approach to local storage by allowing client computers, generally attached to a LAN, MAN (metropolitan area network), or WAN (wide area network), to access many and varied storage devices in a storage area network, thereby eliminating the storage constraints imposed by a limited number of storage devices. A storage server acts as the intermediary between the client computers and the storage devices, communicates with the client computers preferably using standard Internet protocols, and stores the client computers' data in the storage resources in an efficient manner.

The present invention uses a variety of data communication protocols, examples of which are more commonly known today as Internet protocols. Three of these protocols are IP, TCP, and UDP, each of which has specific qualities and characteristics. These data communication or Internet protocols can be used for transmission on or off the public Internet. In addition, these protocols, unlike general broadcast protocols such as IPX (“Internetwork Packet Exchange”) and NetBios, can be routed to individual machines. Moreover, these protocols allow for scalability of networks, in terms of distance, speed, and number of connections. Although the Internet protocols exist today, and are used as exemplary protocols in this description, the present invention is intended to cover other data communication protocols exhibiting these same characteristics.

“Internet Protocol,” commonly known as “IP,” is the most popular method to move data over the public Internet. IP is a connectionless protocol (i.e., it does not require that a connection be maintained during a packet exchange) that resides in the Network layer (layer 3) of the OSI model. IP addresses and routes packets through the network, and fragments and reassembles packets split up in transit. For purposes of this invention, this protocol is insufficient for moving storage traffic. In addition, IP does not guarantee delivery of the packet sequence.

“Transmission Control Protocol,” commonly known as “TCP,” is a connection-oriented protocol, which opens and maintains the connection between two communicating hosts on the network. When an IP packet is sent between the two hosts, a TCP header is added. This header contains information regarding flow control, sequencing, and error checking. TCP is not ideally suited for storage because of the significant overhead required and the negative effect on performance.

“User Datagram Protocol,” or “UDP,” a much simpler protocol than TCP, is a connectionless transport protocol used when the overhead of TCP is not needed. UDP is used to send and receive simple messages, so no session need be established.

The present invention also integrates NAS functionality into SAN technology using a SAN built with a data communication protocol, such as IP, TCP, or UDP. (For the sake of clarity, “IP” is used to denote any combination of the Internet protocols, unless otherwise noted.) NAS and SAN operate through two different protocols. NAS uses the Server Message Block (“SMB”) or Network File System (“NFS”) protocol to share files and folders. NAS client computers use a network redirector to access the shared files and folders. The SAN preferably uses the SCSI protocol to share storage devices, although other protocols, such as IDE, may also be used. SAN client computers use device drivers to access storage blocks on the devices.

The storage server manages the physical storage devices and communicates with the client computers using IP. The storage server converts generic SAN-type storage requests into requests for the storage devices attached to the storage server. The storage server packages responses from the storage devices and sends them back to the client computer that made the request. The storage server can also implement a file sharing protocol, such as SMB or NFS. The storage server services block storage requests for SAN-style client computers as well as file sharing for NAS-style client computers. As a result, a storage server implementing NAS storage access can utilize SAN features to implement more reliable and more available NAS storage through mirroring, high availability server storage, and point-in-time snapshot.

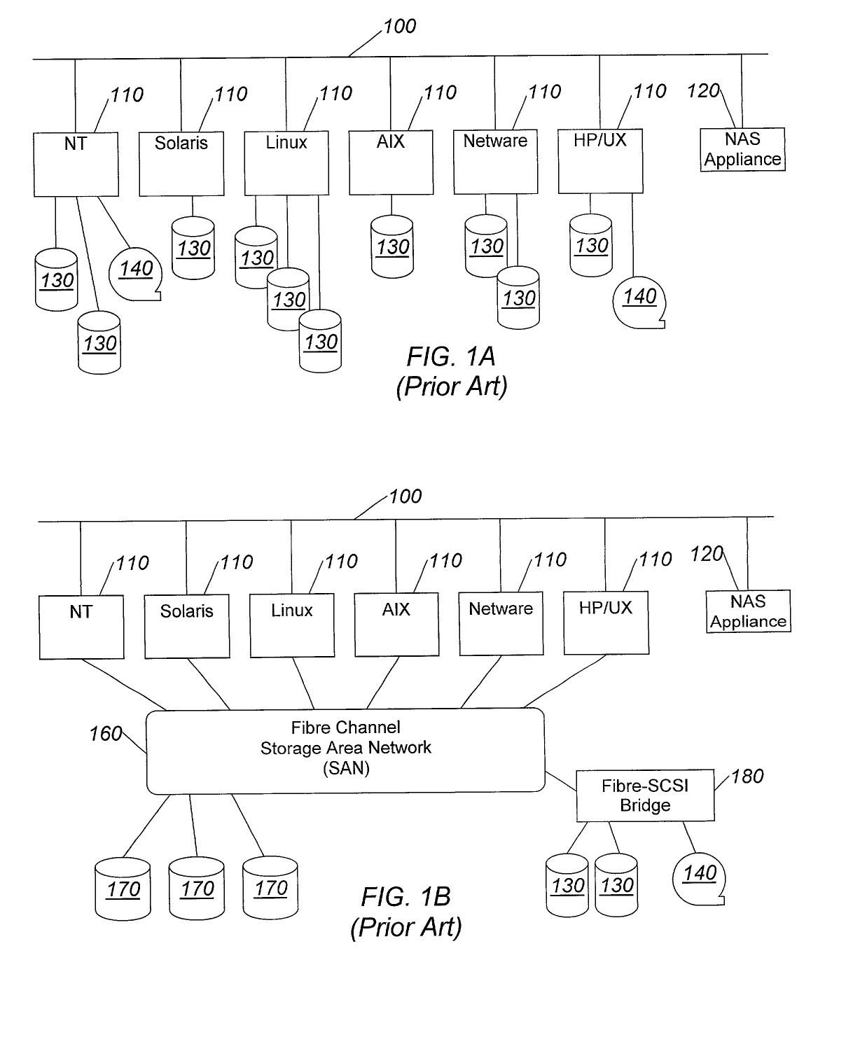

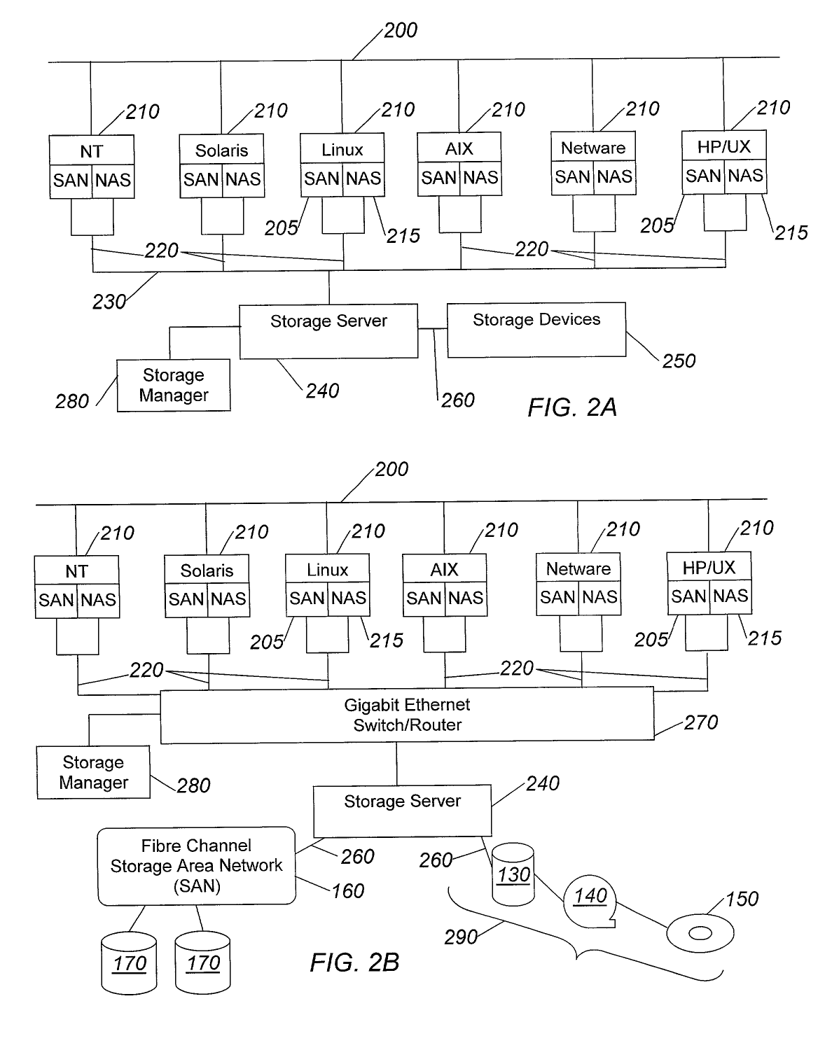

As illustrated in FIG. 2A, one embodiment of the SAN of the present invention consists of one or more client computers 210, each able to act as both a SAN client 205 and a NAS client 215, connected to a computer network 200, such as a LAN, MAN, or WAN, a storage manager 280, one or more storage servers 240, and storage devices 250. (In the description of FIGS. 1A and 1B, SAN client computers 110 were called “servers.” In the description of embodiments of the invention as shown in FIG. 2A and later figures, computers 210, although technically “servers” within the LAN, MAN, or WAN, are “clients” of storage server 240 and will be referred to as such.) Computer network 200 may be based on Ethernet technology, including, but not limited to, Ethernet, Fast Ethernet, and Gigabit Ethernet. Client computers 210 are connected to storage server 240 via data communication protocol (e.g., IP, TCP, and/or UDP) lines 220 and high-speed network 230. High-speed network 230 preferably operates at speeds of 10 Mbps or greater. Storage server 240 is connected to storage devices 250 via standard storage interface 260, which can include SCSI, Fibre Channel, IDE, ESCON® (“Enterprise Systems Connection”), or any other standard storage interface. Storage manager 280 is shown as being connected to storage server 240, but is generally a piece of software that manages the storage devices. The configuration shown in FIG. 2A eliminates NAS appliance 120 of the prior art systems.

Specifically, storage manager 280 sets up, configures, and helps troubleshoot the SAN, keeping track of the components attached to the storage server, and controlling virtualization. In an alternative embodiment, storage manager 280 does not have to be a separate computer or device, as shown in FIG. 2A, but can be run from one of client computers 210. Storage manager 280 is preferably implemented as a JAVA-based console. Storage manager 280 organizes and specifically allocates and authorizes storage resources to client computers 210 on network 200. During the authorization and allocation process, authentication credentials are established using, for example, public key cryptography. Each storage resource is uniquely identified by server name/device ID. Storage manager 280 organizes and manages the storage resources as “virtualized,” where the devices are mapped to real physical geometry. Authorized clients 210, when accessing allocated resources, require strict authentication with proper credentials, using standard IP.

FIG. 2B shows a preferred embodiment of the invention which also includes a high-speed switch 270, using Gigabit Ethernet, for example, where storage manager 280 is shown as being connected to the high-speed switch. High-speed switch 270, like high-speed network 230, preferably operates at speeds of 10 Mbps or greater. Storage devices 250 can include SCSI devices 290 (e.g., disk drives 130, disk libraries 140, and optical storage 150) as well as FC storage devices 170 attached to FC SAN 160. Both SCSI and FC devices are connected to storage server 240 via interfaces 260. Multiple configurations of networks may exist, so long as client computers 210 have a network interface supporting one of the data communication protocols (e.g., IP, TCP, or UDP), and the protocol packets that carry data on the network are routable between any node in the network.

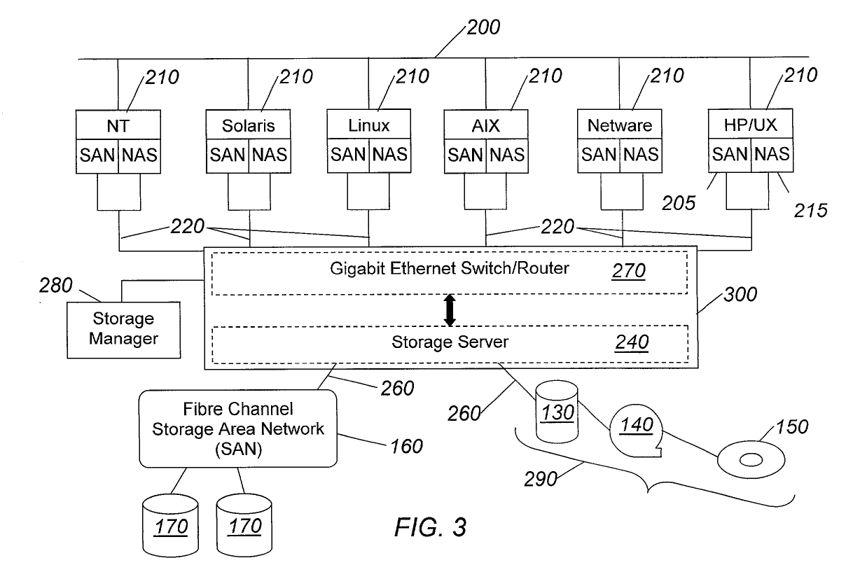

FIG. 3 illustrates an alternative embodiment to that in FIG. 2B in which the switch 270 and the storage server 240 are integrated into a switch/server combination 300. Although storage manager 280 is shown as a separate device in FIG. 3, as discussed with respect to FIG. 2A above, storage manager 280 can be implemented as software on any of clients 210.

The figures show storage server 240 connected to storage devices 290 and 170, for example, via storage interfaces 260. Storage server 240 supports two types of data storage protocols. The first type, for SAN clients, is a “Device Level Access Protocol” (“DLAP”) that transmits and responds to requests for data to be read or written on a block level to storage devices 290 and 170. “Device level” access means that the requests are addressed by sector or block number on the storage device. The SCSI interfaces make storage requests on a block level. The second type of data storage protocol, for NAS clients, is a “File Level Access Protocol” (“FLAP”). This protocol type includes the NAS protocols SMB (Server Message Block) and NFS (Network File Service), as well as Common Internet File System (“CIFS”). These protocols permit shared access to files and folders on a file system. Both data storage protocol types are implemented using IP. The control requests and data transmitted using these data storage protocols are packaged into IP packets. Using IP as the network protocol allows the data storage control requests and data to be routed and transmitted in a wide variety of configurations, including LAN, WAN, and MAN. A client computer 210 can access storage on the storage area network using either FLAP or DLAP or both.

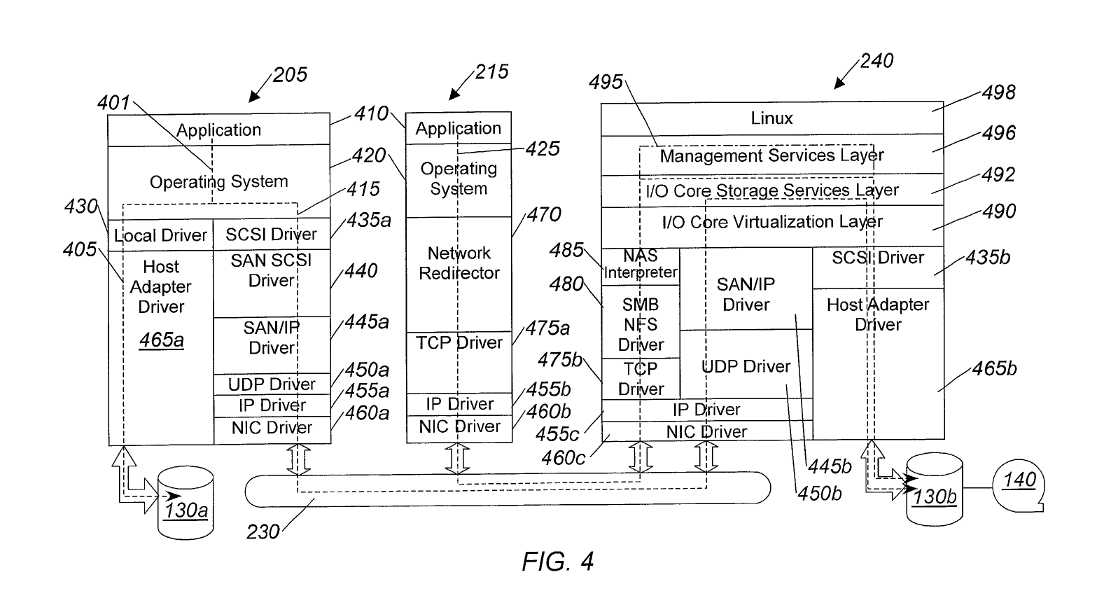

FIG. 4 illustrates an exemplary operation of the invention, for either a SAN client 205 or a NAS client 215. The figure displays an implementation in which SCSI storage-related commands are generated in the client computer and the storage server, but the ability to generate other types of storage-related commands will also be described. Both SAN clients 205 and NAS clients 215 include application layer 410 and operating system 420. SAN clients 205 also include a device driver layer which is shown in FIG. 4 as including local device driver 430 and SCSI device driver 435a. The device driver layer can also include additional device drivers for each type of storage device that the operating system contemplates using. Thus, local device driver 430 would be a SCSI device driver if disk 130a is a SCSI disk. If disk 130a is an IDE disk, local device driver 430 would be an IDE device driver. Similarly, SCSI device driver 435a is shown because it is generally preferable to present a SCSI interface to the operating system; however, it is just as easy, and may be more preferable in certain situations, to present an IDE interface to the operating system, generally in addition to the SCSI interface, but possibly instead of the SCSI interface. In such situations, the device layer would include an IDE device driver. (Analogously, other protocols such as Fibre Channel could also have an FC device driver. It is intended that discussions of protocols such as IDE can include Fibre Channel or other protocols, but for simplicity, these other protocols will generally not be specifically mentioned.) Local device driver 430 drives host adapter driver 465a, whereas SCSI device driver 435a drives SAN SCSI driver 440. If an IDE device driver were included, it would drive a “SAN IDE” driver.

SAN clients 205 also include SAN/IP driver 445a, UDP driver 450a, IP driver 455a, and NIC (Network Interface Card) driver 460a. Note that SAN/IP driver 445a, as will be described below, is not dedicated to a protocol-specific driver in the layer above it. Thus, if SAN client 205 also included an IDE device driver on the device driver layer, SAN/IP driver 445a would also be able to accommodate the SAN IDE driver that interfaces with that IDE device driver.

NAS clients 215 of the invention also include network redirector 470, TCP driver 475a, IP driver 455b, and NIC (Network Interface Card) driver 460b. IP drivers 455a, 455b are identical and NIC drivers 460a, 460b are identical and serve to place IP and network headers, respectively, onto network commands.

Storage server 240 includes provisions for communicating with both SAN and NAS clients. IP driver 455c and NIC driver 460c are complementary to IP drivers 455a, 455b and NIC drivers 460a, 460b, respectively, and serve to remove the IP and network headers from network commands. For SAN clients, storage server 240 also includes UDP driver 450b and SAN/IP driver 445b. For NAS clients, storage server 240 also includes TCP driver 475b, SMB/NFS driver 480, NAS interpreter 485, and management services layer 496. Both types of clients use I/O core virtualization layer 490 and I/O core storage services layer 492, as well as SCSI device driver 435b (if disk 130b is a SCSI device) and host adapter driver 465b. The latter two modules are identical to SCSI device driver 435a and host adapter driver 465a, respectively, except that they operate under the operating system of the storage server, here shown as Linux 498, but other operating systems such as Windows NT® and AIX may easily be used. When storage server 240 stores data on an IDE device, an IDE device driver is included in the device driver layer of the storage server, and a host adapter driver adapted to the IDE device will interface between the IDE device driver and the IDE device.

The operation of the client and the server in FIG. 4 will now be described. A conventional client computer having only local storage includes an application layer, an operating system layer, and a device driver layer. When the client computer initializes, the operating system determines which devices it can access via instructions it receives from the device drivers, which in turn have received instructions from the layer below. When application 410 desires to store data to or retrieve data from a storage device, the application sends a storage request, illustrated by flow line 401, to operating system 420 and directed to that specific device. In order to accommodate the application's request, the operating system must make a series of storage-related requests. Some of these storage-related requests include reading or writing data from the storage device, whereas others include inquiry or status or capacity requests. Based on what the application tells the operating system, for any one of these operating system storage-related requests, the operating system is to decide from which device it should make the request.

FIG. 4 shows flow line 401 splitting into flow lines 405 and 415. A storage-related request will follow flow line 405 if the operating system wants to address local device 130a, as might occur in a conventional client computer. In such a situation, the operating system sends the storage-related request to local device driver 430, which extracts information from the storage-related request and translates the request into commands that can be read by host adapter driver 465a. Host adapter driver 465a reads those commands and executes those commands on device 130a, which sends a response back to operating system 420 along flow line 405. All requests made from operating system 420 are executed on disk 130a.

A storage-related request will follow flow line 415 if the operating system wants to address a device specified by SCSI device driver 435a. (Similarly, the flow will go to an IDE device driver if the operating system wants to address a device specified by the IDE device driver.) SCSI device driver 435a (or an IDE device driver) is found in conventional client computers. On initialization, however, SCSI device driver 435a was instructed by SAN SCSI driver 440, which is part of the present invention, to forward all of the SCSI device driver commands to it. The operating system does not know that the device ultimately addressed by SCSI device driver 435a is not physically attached to the client computer. To the operating system, all storage-related requests that it generates for storage device access are treated the same, i.e., they are sent to a device driver and the device driver returns some response.

SCSI device driver 435a translates the storage-related request from the operating system to a storage-related SCSI command or commands that can be read by SAN SCSI driver 440. (An IDE device driver would translate the storage-related request from the operating system to a storage-related IDE command or commands that can be read by a SAN IDE driver.) SAN SCSI driver 440 determines whether the storage-related request is to be responded to by the storage server or can be responded to locally. If it is to be responded to locally, SAN SCSI driver 440 can generate a local response and send it back to SCSI device driver 435a. Thus, unlike a conventional client computer, not every storage-related request must be executed on a storage device. In this manner, SAN SCSI driver 440 provides a first level of virtualization of the present invention.

If the storage server is to respond to the storage-related request, SAN SCSI driver 440 translates the storage-related SCSI commands into more generic storage-related requests that can be read by SAN/IP driver 445a, also forming part of the present invention. Because these generic storage-related requests are not protocol-specific, a SAN IDE driver that receives IDE commands from an IDE device driver would translate the IDE commands to these more generic storage-related requests that can be read by SAN/IP driver 445a. By converting device-specific commands to generic storage-related requests, SAN/IP driver 445a provides a second level of virtualization of the present invention.

SAN/IP driver 445a takes the generic storage-related request and prepares it for transmission over the high-speed network, including enhancing the reliability of UDP. The generic storage-related request is sent to UDP driver 450a, then to IP driver 455a, and then to NIC driver 460a to transmit the generic storage-related request over high-speed network 230 to storage server 240.

In the operation of the NAS client of the present invention, as shown by NAS client flow line 425, the request to communicate with a storage device is transmitted to network redirector 470, which is generic to a NAS client. Network redirector 470 is software whose purpose is to redirect tasks or input/output (I/O) to network devices such as disks and printers. When network redirector 470 receives a task or I/O request, it determines whether the task or request will be performed locally or sent over the network to a remote device. Network redirector 470 then sends the request to TCP driver 475a, then to IP driver 455b, and then to NIC driver 460b to transmit the request over high-speed network 230 to storage server 240.

From high-speed network 230, both SAN and NAS generic storage-related requests are received by NIC driver 460c and sent to IP driver 455c. A NAS request is then sent to TCP driver 475b, which is then received by SMB/NFS driver 480, and then received by NAS interpreter 485 which sends a storage-related command to I/O core virtualization layer 490. A SAN generic storage-related request is sent to UDP driver 450b and then to SAN/IP driver 445b which prepares it to be read by I/O core virtualization layer 490, the operation of which will be described below. Both SAN and NAS requests are sent to I/O core storage services layer 492 for any interaction with the storage devices, from simple storage or retrieval to one of the storage services such as client-free server backup, replication, mirroring, or high availability are required. A NAS request may also be transmitted, as shown by flow line 495, to management services layer 496 in order to configure NAS resources. The management services available here are similar to those available using storage manager 280 for SAN clients. If applicable, commands destined for storage devices are sent back through I/O core virtualization layer 490 to SCSI device driver 435b, to host adapter driver 465b, and then to SCSI devices 130b, 140. (For requests requiring access to IDE storage devices, the generic commands would be converted to IDE commands in I/O core virtualization layer 490, transmitted to an IDE driver, then to a host adapter driver specific for IDE devices, and then to the IDE devices for data storage or retrieval.) The storage devices send a response back to I/O core virtualization layer 490 along flow lines 415, 425, and a generic reply is generated and sent back across high-speed network 230 to the respective client computer, and ultimately to the operating system. Because of virtualization, client computers 210 do not know that a locally-attached disk did not process the request. This is another level of virtualization of the present invention.

More specifically, SAN client 205 operates as follows. Client computer 210 includes software composed of a job control daemon, located in operating system 420, and a kernel driver (represented by SAN SCSI driver 440). The job control daemon initializes and sets up the control and monitoring operation of SAN SCSI driver 440, which then implements SAN/IP driver 445a. Operating system 420 discerns no difference between SAN/IP driver 445a and any other standard SCSI host adapter driver 465a. SAN/IP driver 445a uses standard IP service to connect to the authorized storage server 240. Allocated storage resources from storage server 240 are identified by server name/device ID, which is mapped to the local SCSI ID and logical unit number (“LUN”) under SAN/IP driver 445a. This adapter/SCSI ID/LUN represents the remote storage device 130b to the local operating system as a locally-attached SCSI resource.

During initialization, the daemon validates to the server a communications pathway, creating an access token for all subsequent SAN client-storage server communications. The storage resources now appear to operating system 420 as locally-attached storage. Operating system 420 then issues storage-related requests, which are converted in SCSI device driver 435a to storage-related commands, which are then directed in SAN SCSI driver 440 to a specific SCSI ID and LUN inside SAN/IP driver 445a. SAN SCSI driver 440 receives the storage-related request and then maps the SCSI ID/LUN to the server name/device ID so that the remote storage resource (e.g., 130b) can be identified. Once identified, a generic storage-related request package is created in the form of an open network computing remote procedure call (“ONC-RPC” or just “RPC”). The RPC package contains the access token, the original generic storage-related command, and the target device ID. Preferably, this package is sent through a layer in SAN/IP driver 445a that enhances the reliability of UDP, before being transmitted to UDP driver 450a for a UDP header, IP driver 455a for an IP header, and NIC driver 460a for transmission over the network 230. This package is sent to storage server 240, where storage server 240 is listening over IP.

When a generic storage-related request from authorized client 205 arrives at storage server 240, the server uses the device ID to identify the local physical storage resources associated with the particular device ID. Because the request is virtualized, the embedded command is interpreted and re-mapped to the appropriate physical device and physical sectors. Multiple commands (e.g., SCSI, IDE) may have to be executed to service a single request. The result of the execution is packaged as a generic storage-related reply to the client. This reply, when received by client 205, is converted to a local SCSI (or IDE) completion response and returned to the operating system to complete the request.

Another way of looking at SAN client requests is as follows. A SAN client request supports device level access protocol (DLAP). If client computer 205 needs device level access, it will use SAN/IP driver 445a. Most computer operating systems define a standard application program interface (“API”) for accessing SCSI storage devices. In the present invention, SAN/IP driver 445a implements the standard API for the particular operating system (e.g., Windows NT®, Solaris™, Linux, etc.). This makes the DLAP data storage interface appear to the operating system as would a locally-attached SCSI storage device. Operating system 420 reads and writes data to the remote storage device 130b attached to the SAN in the same way as it does to locally-attached SCSI storage device 130a. When operating system 420 makes a storage-related request to SAN/IP driver 445a, SAN/IP driver 445a converts the request into IP packets. SAN/IP driver 445a examines the request to determine for which storage server 240 the request was meant, and then delivers the storage-related request, in IP packet form, to storage server or servers 240 that need to service the request. In some cases, storage-related requests may involve multiple storage devices 130, 140, 150. Storage server 240 receives the DLAP requests over the network, converts the IP packets into SCSI commands, and issues these new commands to the storage device or devices 130, 140, 150 attached to storage server 240. Storage server 240 receives the data and/or status from storage device 130, 140, 150 and constructs a response for the client computer 205 that made the request. The storage server converts the response into IP packets and sends the response back to SAN/IP driver 445a on the client computer 205 that made the initial request. SAN/IP driver 445a on client computer 205 converts the IP packets into a response for operating system 420. The response is returned to operating system 420 through the API that initiated the request. Because of the device driver that acts like a virtual SCSI device driver (i.e. SAN/IP driver 445a), operating system 420 believes that the requests are all being responded to locally.

In a somewhat analogous manner, a NAS client 215 uses file level access as the standard access protocol. If the NAS client 215 needs file level access, it implements a FLAP such as System Message Block (“SMB”), Common Internet File System (“CIFS”), a variant of SMB, and Network File System (“NFS”). These protocols are well defined and in common use for accessing network-attached storage in computer networks such as the one employed in the present invention. Client computer 215's operating system 420 makes the FLAP storage-related requests using SMB/CIFS or NFS. These protocols are implemented with the TCP/IP protocol, and thus can be transmitted to storage server 240. Storage server 240 implements one or more of the FLAPs as a server, i.e., it handles requests from clients 215 that make requests. Requests for files and or folder information are sent back to the client 215 using the FLAP (e.g., SMB/CIFS or NFS) that initiated the request. The storage server manages a file system, which is a system of managing computer files and folders for use by computer programs. The file system holds the files and folders shared through the FLAP. The file system typically is stored and maintained on remote disk storage 130, 140, 150, such as those connected to storage server 240. The file service stores and retrieves data for the file system using storage server 240. Because the storage server uses a device-level protocol to store and maintain its file system, the SAN's features are transparent. NAS client computers 215 that use FLAP do not know that the files and folders are stored on SAN devices. This is a further level of virtualization of the present invention.

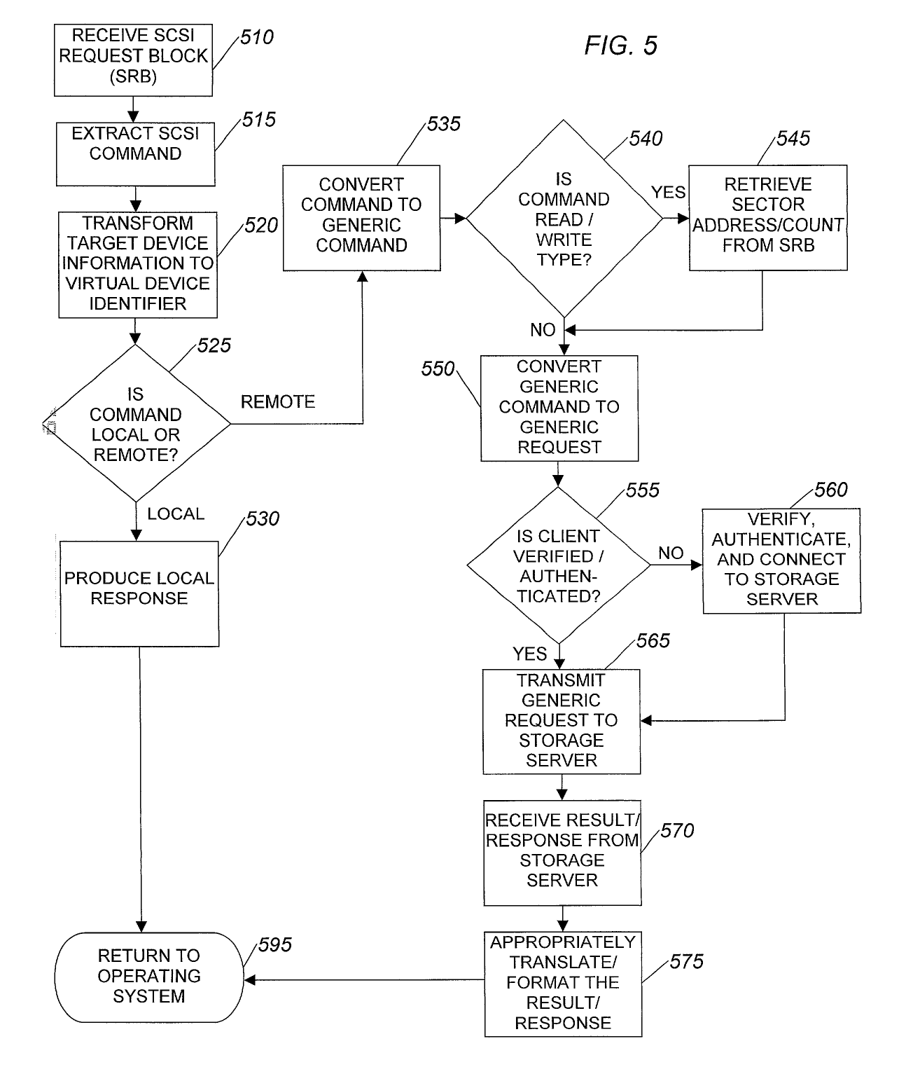

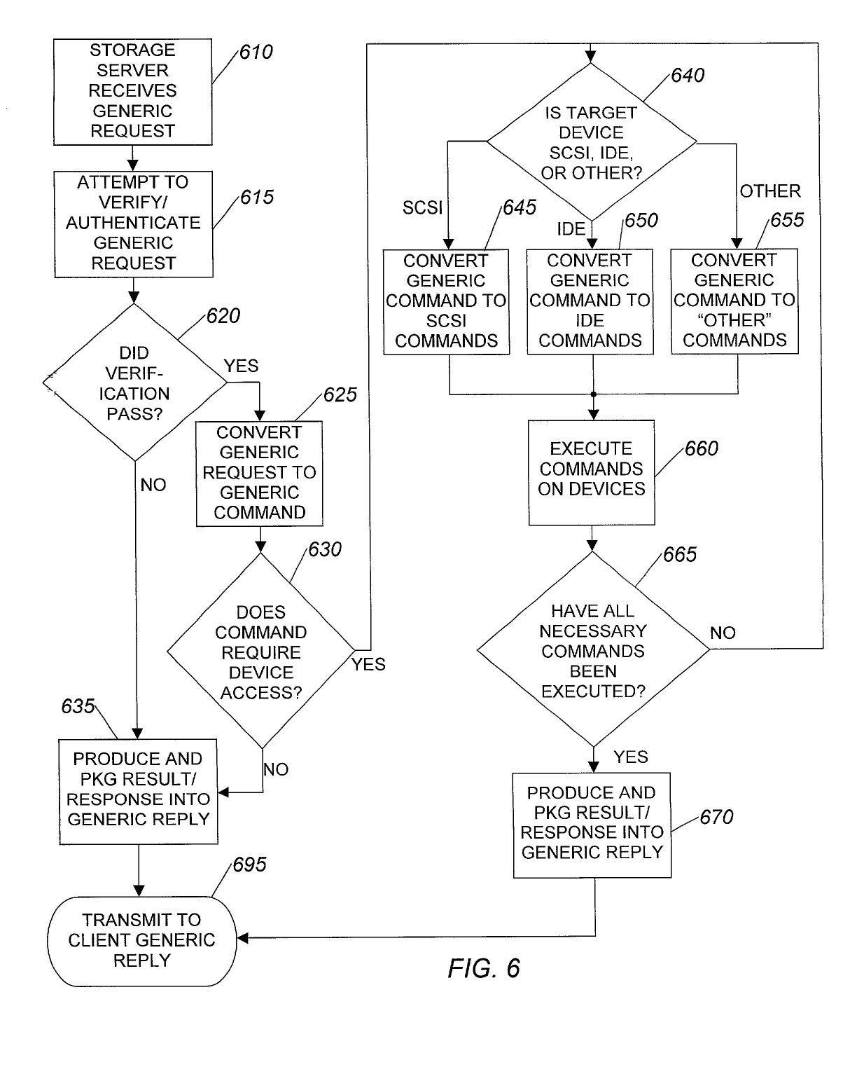

FIGS. 5 and 6 are flowcharts that illustrate a preferred embodiment of the present invention client and storage server operations. FIG. 5 describes the client's operations with respect to how the configuration of FIG. 4, which includes SCSI device driver 435a and SAN SCSI driver 440, would operate. (IDE requests could also be made using an IDE device driver and a SAN IDE driver.) In step 510, a SCSI request block (SRB) is received by SAN SCSI driver 440 from SCSI device driver 435a. In step 515, SAN SCSI driver 440 extracts the SCSI storage-related command from the SRB. In step 520, SAN SCSI driver 440 retrieves from the SRB SCSI target information (SCSI ID/LUN) and transforms it into a virtual device identifier. In step 525, SAN SCSI driver 440 analyzes the SCSI storage-related command to determine if it is to be completed locally or remotely. A locally-completed command include a command such as an “Inquiry” or “Report LUN” command, using SCSI commands as an example. If the storage-related command is to be completed locally, in step 530 SAN SCSI driver 440 produces an appropriate response to the SCSI storage-related command, without use of storage server 240. Step 595 then returns to operating system 420.

If the storage-related command is to be completed remotely, SAN SCSI driver 440 converts the storage-related command into a generic storage-related request, as follows. Step 535 converts the storage-related command, in this case a SCSI command, to a generic storage-related command. Step 540 asks whether the generic command is a “Read” or “Write”-type (i.e., device) command. If so, step 545 retrieves the sector address and sector count from the SRB to prepare for transmission to storage server 240 via an RPC. If the generic storage-related command is not a Read or Write-type command, or once the sector address and count are retrieved, step 550 converts the generic storage-related command to a generic storage-related request by putting the virtual device identifier together with the generic storage-related command. Generic non-Read/Write commands might include “Ready,” “Identify,” and “Capacity,” which, if ultimately executed on a SCSI device, might translate as SCSI storage-related commands to “Test Unit Ready,” “Get Device Information,” and “Get Capacity,” or, in some cases, may result in the execution of multiple SCSI commands on the SCSI device. A generic storage-related request is used because the present invention is designed to support device protocols other than just SCSI (e.g., IDE, FC, ESCON). A generic storage-related request derived from a device protocol other than SCSI is generated in a manner analogous to that illustrated in FIG. 5, and the resulting request generated in step 550 would have the same format regardless of the initial protocol used.

Once a generic storage-related request is generated, it is sent to SAN/IP driver 445a. In step 555, SAN/IP driver 445a asks whether the client is verified and authenticated and connected to storage server 240. If not, step 560 verifies and authenticates the client and connects to storage server 240. Once the client is verified, authenticated, and connected, step 565 enhances the reliability of the UDP protocol and transmits the generic storage-related request via RPC to storage server 240. After storage server 240 acts on the request as described in the flowchart of FIG. 6, the completed results and/or responses are received by SAN/IP driver 445a from storage server 240 in step 570. The response is sent back to SAN SCSI driver 440 which, in step 575, translates or formats appropriately the received results/responses, and returns the response to operating system 420 in step 595.

FIG. 6 describes the storage server's operations. In step 610, SAN/IP driver 445b in storage server 240 receives the generic storage-related request. In step 615, SAN/IP driver 445b attempts to verify and authenticate the request. In step 620, I/O core virtualization layer 490 takes over and asks if the verification succeeded. If so, step 625 converts the generic storage-related request to a generic storage-related command. Step 630 then asks whether the generic storage-related command requires access to a device for completion. The answer to this is yes if the generic storage-related command is one such as a Read or a Write. If the generic storage-related command is one such as Ready, Identify, or Capacity, which does not need device access to complete, step 635 produces the appropriate results and/or responses and packages the results into a generic storage-related reply. A generic storage-related reply is also generated if the verification/authentication in step 620 failed. Step 695 then transmits this generic storage-related reply back to the client that sent the request.

If the answer to step 630 is yes, a Read or Write-type command has been issued. Step 640 asks whether the generic storage-related command is directed to a SCSI, IDE, or other target device. If SCSI, step 645 converts the generic storage-related command to appropriate physical SCSI command equivalents. Likewise, if IDE, step 650 converts the generic storage-related command to appropriate physical IDE command equivalents. Similarly, if the generic storage-related command is directed to a target device operating under another protocol, step 655 converts the generic storage-related command to appropriate physical command equivalents for that other protocol. Step 660 then executes the commands on the target devices, and step 665 asks whether all of the necessary commands have been executed. If not, the flowchart returns to step 640 to again determine which kind of target device the commands are directed to (which may be different from the previously executed command). Once all the necessary commands have been executed, step 670 packages the results and/or responses into a generic storage-related reply which step 695 then transmits back to the client that sent the request.

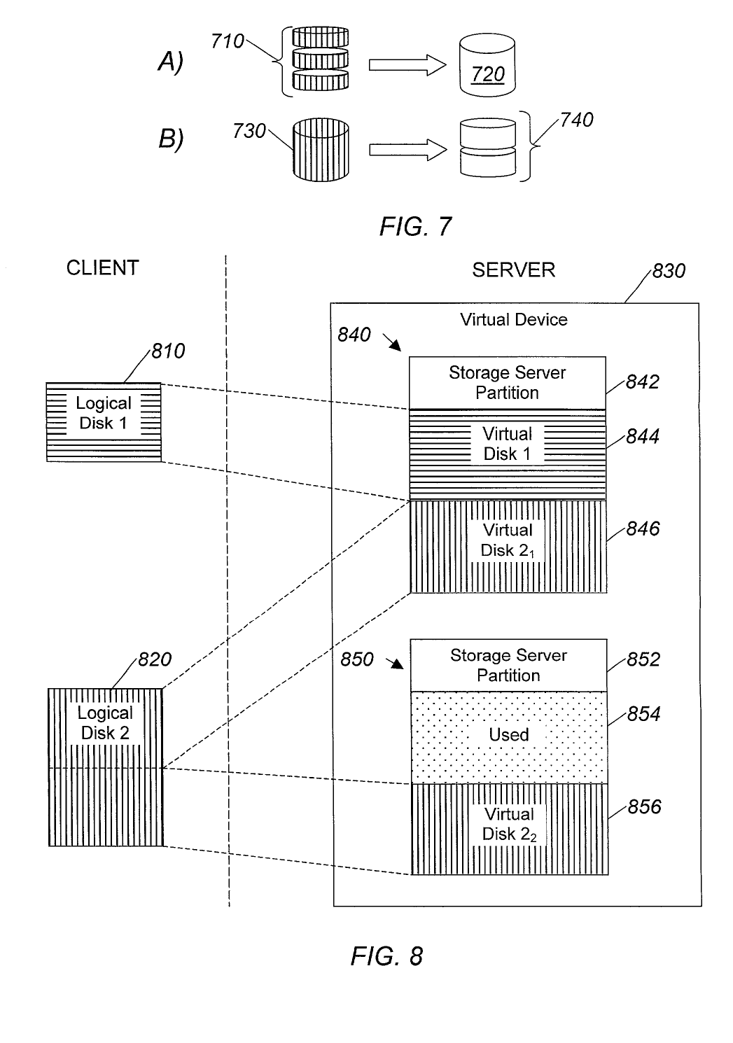

FIGS. 7 and 8 illustrate the virtualization capabilities of the present invention. In FIG. 7A, three physical disks 710, e.g., 20 GB each, are mapped to a 60 GB virtual disk 720. Alternatively, in FIG. 7B, a single physical disk 730, e.g., 80 GB, is mapped to two 40 GB virtual disks 740.

FIG. 8 illustrates several layers of disk virtualization on the client side and the server side. On the client side are two logical disks 810, 820, both starting at logical sector address 0. On the server side is a single virtual device 830. In FIG. 8, virtual device 830 is shown as a disk, however, virtual device 830 (as well as logical disks 810, 820) are not limited to disks, but can be another device type of device, such as a scanner, a tape drive, a CD-ROM drive, or an optical drive, which is capable of being virtualized. In this example, one virtual device 830 is made up of two physical disks 840, 850. Each physical disk 840, 850 includes a partition 842, 852, respectively, which defines the mapping of the respective disk. In this example, physical disk 840 includes two virtual disks, 844 and 846, whereas physical disk 850 includes a used area 854 and a virtual disk 856. Logical disk 810 is mapped to virtual disk 844 in physical disk 840, and its logical sector address 0 is mapped starting at physical sector address N, located below partition 842. Logical disk 820 is mapped to two virtual disks, 846, 856, each of which resides on different physical disks, 840, 850, respectively. Because of the presence of partition 842 and virtual disk 844, logical sector address 0 of logical disk 820 is mapped starting at physical sector address M of physical disk 840.

For the two logical disk situations 810, 820, the client operation is the same. In both cases, the client receives a SCSI storage-related command from the operating system (steps 510-515). The SCSI storage-related command is converted to a generic storage-related request (steps 535-550) and sent over the high-speed network to storage server 240 (step 565). The generic storage-related request is received by storage server 240 (step 610). For the single-drive operation using logical disk 810, the generic storage-related request is transformed into a command for the server's SCSI drive, but at a sector address different from that specified in the original SCSI storage-related command in the client. That server command is then executed on that SCSI device. For the dual-drive operation using logical disk 820, the storage server first determines that the SCSI storage-related command is requesting an storage-related operation that requires two drives to complete. The generic storage-related request is transformed into two commands, one for each of the server's physical SCSI drives, and both at sector addresses different from that specified in the original SCSI storage-related command in the client. The commands are then executed on those SCSI devices.

The virtualized resource also works for NAS applications. Incorporating NAS client 215 access in the virtualized storage design offers file system access to NAS clients 215 over the Gigabit Ethernet infrastructure without impacting the user LAN bandwidth. In addition, virtualization, high-speed backup snapshot, mirroring, and replication are also available to NAS clients using the existing production-user LAN.

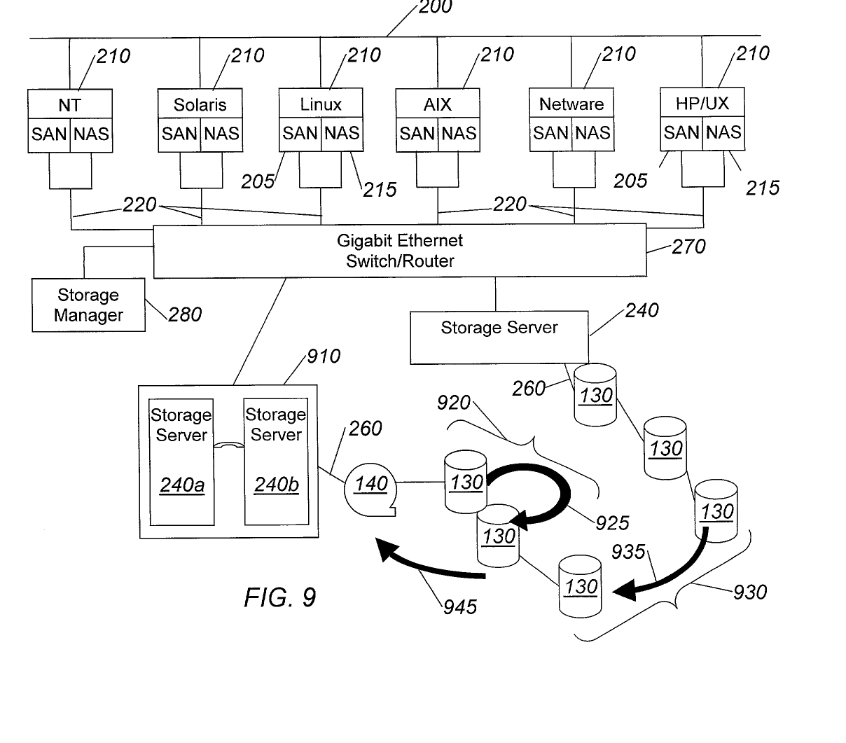

Several of these features are illustrated schematically in FIG. 9. The SAN in FIG. 9 is similar to the SANs depicted in FIGS. 2A and 2B. Standalone storage server 240 is connected to high-speed switch 270. A group of disk drives 130 is connected to standalone storage server 240 via storage interface 260. Differing from FIGS. 2A and 2B, FIG. 9 also includes, in addition to standalone storage server 240, high availability group 910 connected to high-speed switch 270. High availability group 910 consists of two storage servers 240a, 240b connected together, each identical to standalone storage server 240. Attached to high availability group 910 via storage interface 260 are disk library 140 and several disk drives 130. Two of these disk drives 130 comprise mirrored pair 920, and the other disk drive 130 is included as part of replication group 930 with one of the disk drives 130 daisy-chained to standalone storage server 240.

Mirroring occurs when two drives are written to at the same time. This is illustrated in FIG. 9 using mirrored pair 920. Mirroring arrow 925 indicates that each file or block that is saved to one disk drive 130 of the pair is also saved to the other disk drive 130 of the pair, thus providing redundancy of data in the event one of the disk drives fails.

The result of replication, redundant disk drives, is the same as that of mirroring, but is accomplished in a different way. Instead of saving each file or block to two drives at the same time, the contents of one disk drive 130 are periodically copied to the other disk drive 130. This is illustrated in FIG. 9 using replication group 930. Replication arrow 935 indicates that at certain times, either scheduled or on demand, the contents of the disk drive 130 (in replication group 930) that is daisy-chained to standalone server 240 are copied to the disk drive 130 (in replication group 930) that is daisy-chained to high availability group 910.

Another feature of the invention is SAN-client-free backup, indicated in FIG. 9 by arrow 945. This feature allows the data from one of the disk drives 130 of mirrored pair 920, for example, to be backed up to disk library 140 attached to high availability group 910 without using the resources of client computers 210. Storage servers 240a, 240b control the backup, thus allowing client computers 210 to take care of other tasks for their clients.

The present invention maximizes and exploits the capabilities of data communication protocols such as IP, TCP, and UDP to create an efficient and effective methodology for moving storage over Ethernet. Using hardware-independent architecture, the present invention accommodates a variety of storage device interfaces, including SCSI, FC, IDE, and others, and is able to connect segregated islands of existing FC SANs using IP. By leveraging existing industry standards such as FC, Gigabit Ethernet, and other high-speed network infrastructures, the invention breaks the traditional boundaries of device and interface protocol and delivers the expected benefits of SAN and NAS, plus additional features such as enterprise-wide storage virtualization, replication, mirroring, snapshot, backup acceleration, high-availability servers, end-to-end diagnostics, and reporting. The invention can also plug security holes by supporting encryption (e.g., using hardware virtual private network (“VPN”) boxes) and providing key-based authentication, thereby eliminating the possibilities of snooping and spoofing.

It should be understood by those skilled in the art that the present description is provided only by way of illustrative example and should in no manner be construed to limit the invention as described herein. Numerous modifications and alternate embodiments of the invention will occur to those skilled in the art. Accordingly, it is intended that the invention be limited only in terms of the following claims.

We claim:

1. A system for storing and/or retrieving data, comprising:
a client computer having data to store or desiring to retrieve data;
a storage server in communication with the client computer and capable of reading storage-related requests communicated from the client computer;
a high-speed network running at least one data communication protocol for communicating between the client computer and the storage server;
a storage device having data to retrieve and for storing data, wherein the storage device is in communication with the storage server; and
a storage manager in communication with the storage server for allocating and authorizing the storage device.

2. The system according to claim 1, wherein the data communication protocol is selected from the group consisting of Internet Protocol (“IP”), Transmission Control Protocol (“TCP”), and User Datagram Protocol (“UDP”).

3. The system according to claim 1, further comprising a high-speed switch for communicating between the client computer and the storage server.

4. The system according to claim 3, wherein the high-speed switch and the storage server are integrated.

5. The system according to claim 1, wherein the storage device is selected from the group consisting of SCSI, Fibre Channel, IDE, and ramdisk devices.

6. The system according to claim 1, further comprising at least one other storage device, wherein storing the data comprises mirroring the data of one of the storage devices onto the other storage device.

7. The system according to claim 1, further comprising at least one other storage device, wherein storing the data comprises replicating the data of one of the storage devices onto the other storage device.

8. The system according to claim 1, further comprising at least one other storage server for providing high availability data storage.

9. The system according to claim 1, further comprising at least a second storage device, wherein the data on the storage device is backed up to the second storage device without involving the use of the client computer.

10. The system according to claim 1, wherein the client computer is capable of operating as both a storage area network (“SAN”) client and a network-attached storage (“NAS”) client.

11. The system according to claim 1, wherein the client computer further comprises a driver for determining whether a storage-related command is to be communicated to the storage server.

12. The system according to claim 11, wherein the data communication protocol is User Datagram Protocol (“UDP”) running over Internet Protocol (“IP”).

13. The system according to claim 12, wherein the driver enhances the reliability of UDP.

14. The system according to claim 11, wherein the storage-related command is not communicated to the storage server, but instead is responded to by the driver, and wherein it appears to the client computer that the response to the storage-related command is coming from a storage device connected directly to the client computer.

15. The system according to claim 11, wherein the storage-related command is communicated to the storage server in the form of a generic storage-related request.

16. The system according to claim 15, wherein the generic storage-related request is device protocol-independent.

17. The system according to claim 15, wherein the generic storage-related request is not communicated to the storage device, but instead is responded to by the storage server in the form of a generic storage-related reply, and wherein it appears to the client computer that the response to the storage-related command is coming from a storage device connected directly to the client computer.

18. The system according to claim 15, wherein the storage device is virtualized.

19. The system according to claim 18, wherein the generic storage-related request is communicated to the storage device.

20. The system according to claim 19, wherein the generic storage-related request is converted to a second storage-related command capable of being executed on the storage device, and the storage device responds to the second storage-related command and communicates the response to the storage server.

21. The system according to claim 20, wherein the storage server converts the response to the second storage-related command into a generic storage-related reply and communicates the generic storage-related reply to the client computer, and wherein it appears to the client computer that the storage device is connected directly to the client computer.

22. The system according to claim 18, wherein the storage device appears as a single virtual device.

23. The system according to claim 22, wherein the single virtual device comprises at least one physical device.

24. The system according to claim 23, wherein the physical device comprises at least one virtual device.

25. A method for storing and/or retrieving data, comprising:
communicating over a high-speed network at least one storage-related request from a client computer to a storage server, the network running at least one data communication protocol;
allocating and authorizing a storage device in communication with the storage server; and
storing data on and/or retrieving data from the storage device.

26. The method according to claim 25, wherein the data communication protocol is selected from the group consisting of Internet Protocol (“IP”), Transmission Control Protocol (“TCP”), and User Datagram Protocol (“UDP”).

27. The method according to claim 25, wherein the storage device is selected from the group consisting of SCSI, Fibre Channel, IDE, and ramdisk devices.

28. The method according to claim 25, wherein the client computer is capable of operating as both a storage area network (“SAN”) client and a network-attached storage (“NAS”) client.

29. The method according to claim 25, wherein the data communication protocol is User Datagram Protocol (“UDP”) running over Internet Protocol (“IP”).

30. The method according to claim 29, further comprising enhancing the reliability of UDP.

31. The method according to claim 25, further comprising virtualizing the communication between the client computer and the storage device.

32. The method according to claim 31, wherein the virtualizing comprises not communicating to the storage server a storage-related command, but instead responding to the storage-related command so that it appears to the client computer that the response to the storage-related command is coming from a storage device connected directly to the client computer.

33. The method according to claim 31, wherein the virtualizing comprises converting the storage-related command to a generic storage-related request, wherein the generic storage-related request is device protocol-independent.

34. The method according to claim 33, further comprising not communicating the generic storage-related request to the storage device, but instead responding to the generic storage-related request so that it appears to the client computer that the response to the storage-related command is coming from a storage device connected directly to the client computer.

35. The method according to claim 34, further comprising converting the generic storage-related request to a second storage-related command capable of being executed on the storage device, the storage device responding to the second storage-related command and communicating the response to the storage server.

36. The method according to claim 35, further comprising converting the second storage-related command into a generic storage-related reply and communicating the generic storage-related reply to the client computer so that it appears to the client computer that the storage device is connected directly to the client computer.

37. The method according to claim 31, wherein the virtualizing comprises making the storage device appear as a single virtual device.

38. The method according to claim 37, wherein the single virtual device comprises at least one physical device.

39. The method according to claim 38, wherein the physical device comprises at least one virtual device.

40. A system for accessing a peripheral device, comprising:
a client computer;
a server in communication with the client computer and capable of reading peripheral device-related requests communicated from the client computer;
a high-speed network running at least one data communication protocol for communicating between the client computer and the server; and
a manager in communication with the server for allocating and authorizing the peripheral device,
wherein the peripheral device is remote from the client computer and in communication with the server.

41. The system according to claim 40, wherein the peripheral device is selected from the group consisting of SCSI, Fibre Channel, and IDE devices.

42. The system according to claim 40, wherein the communication between the client computer and the peripheral device is virtualized.

43. The system according to claim 42, wherein it appears to the client computer that the peripheral device is connected directly to the client computer.

44. The system according to claim 42, wherein the peripheral device appears as a single virtual device.

45. The system according to claim 44, wherein the single virtual device comprises at least one physical device.

46. The system according to claim 45, wherein the physical device comprises at least one virtual device.
